(19) United States
(12) Patent Application Publication
(10) Pub. No.: US 2008/0236354 A1
(43) Pub. Date: Oct. 2, 2008

(54) UNIVERSAL CUTTING ASSEMBLY FOR CUTTING MACHINES OF SHEET MATERIAL

(75) Inventor: Francesco Esposito, Magneta (MILANO) (IT)

Correspondence Address: YOUNG & THOMPSON, 209 Madison Street, Suite 500, ALEXANDRIA, VA, 22314, US

(73) Assignee: ESPO S.R.L., CORBETTA (IT)

(21) Appl. No.: 12/052,755

(22) Filed: Mar. 21, 2008

(30) Foreign Application Priority Data
Mar. 26, 2007 (EP) 07425175.2

(51) Int. Cl. B26D 1/24; B26D 5/04; B26D 7/18

(52) U.S. Cl. 83/169; 83/502; 83/177

(57) ABSTRACT

Universal cutting assembly for rotary shear, pressure or blade cutting machines of different sheet materials, of the type comprising a fixed, upper support body (T), a disc-holder unit (U) connected to said support body so as to be able to rotate by at least 180° along a vertical axis, a support flange (F) for a cutting disc (D) housed in the disc-holder unit (U). Flange (F) is subject to a perpendicular displacement to the cutting surface for moving disc (D) closer to/away from the cutting area, driven by the action of a pressurised fluid on first piston means (3), and by a displacement parallel to the cutting surface for positioning the disc (D) with respect to a counterdisc arranged below the cutting surface, driven by the action of a pressurised fluid on second piston means (17). The disc-holder unit (U) comprises an automatic device for stopping the cutting disc (D) in a rest position, which device is actuated by respective piston means in fluid connection with said second piston means.

The present invention concerns a universal cutting assembly for rotary, shear, pressure or blade cutting machines of different sheet materials.

Cutting machines consisting of a series of adjacent cutting assemblies are known in the art, which are capable of simultaneously cutting strips of large sheet materials, such as paper and other cellulose derivatives, fabrics, plastic materials, rubbers, metals, and other types of flexible materials.

Each individual cutting assembly comprises a disc-holder unit, whereon a sharp-edged disc is pivoted, freely rotating. In the case of rotary shear cutting or pressure cutting, in correspondence of the cutting disc, and below the working surface, there is further provided a counterdisc, driven by suitable motor means, capable of transmitting its movement to the cutting disc when the latter is pushed against a side surface thereof (shear cut) or against its front surface (pressure cut).

The disc-holder unit is capable of allowing the cutting disc to perform both a movement perpendicular to the cutting surface and a movement parallel thereto. The perpendicular movement allows the cutting disc to move closer to/further away from the counterdisc in a radial sense, while the parallel movement allows the cutting disc edge to move laterally closer to/away from the corresponding edge of the counterdisc.

The rotary shear cut is performed with extreme accuracy by the combined action of the cutting disc and counterdisc which—thanks to the partial mutual lateral overlapping—perform in a rotary way a cut fully similar to that of a pair of shears. Of course, the cut can be easily interrupted and resumed by simply varying the relative position of the cutting disc with respect to the counterdisc.

In the case of the pressure cut, the cutting disc is instead positioned in contact with the front surface of the counterdisc and kept pushed against the same surface by a suitable pressure. As a matter of fact, in this case the cutting action is due to the pressing action by the cutting disc on the material, which for this purpose has a very thin cutting edge (even though suitably rounded off in order not to spoil the counterdisc) Finally, in the case of the blade cut, the cutting blade is fixed, suitably inclined with respect to the sheet material which translates in a longitudinal direction with respect to the same, the blade fully cutting into the thickness thereof. If said material is sufficiently taut, the cut can be performed in a “free” way i.e. without supporting the material in correspondence of the cutting area; otherwise the cut is performed in correspondence of a grooved roll whereon the material rests, the cutting blades being of course located in correspondence of the disc grooves.

While the counterdisc is installed on the machine body in a stationary or mobile manner, the cutting disc must have a structure capable of allowing an easy and quick replacement thereof, as well as a fast and accurate adjustment of the lateral or front support position on the counterdisc, in order to avoid any risk of defective cuts or early or irregular wear of the cutting discs.

The art has implemented various devices in order to improve the performance of the cutting assemblies of the various abovedescribed types, which, however, still have some drawbacks, the overcoming whereof is addressed by the present invention.

A first drawback of the known cutting assemblies consists in the fact that they must normally be specifically prearranged according to the type of cut they are intended for, i.e. rotary shear cut, pressure cut, or blade cut. A first object of the present invention is hence that of providing a universal cutting assembly, whereby it is hence possible to perform any desired type of cut, subject to the simple replacement of the cutting disc.

A second drawback of known cutting assemblies is that the disc-holder unit of such assembly cannot quickly rotate by 180° —as is desirable in some types of processes—due to the presence of the outer pipes of the pneumatic system associated therewith, whereby the lateral shift of the cutting disc is driven with respect to the disc-holder unit, which pipes of course slow down the rotation operation because they need to be disconnected from the unit and mounted back on in a new position following rotation of the same. As a matter of fact, this drawback had already been overcome by utility model IT-U-223901, in the name of the same Applicant, wherein both movements, the lowering and the lateral shifting one, of the cutting disc were performed through a single pneumatic control located inside the upper (non-rotary) support of the cutting assembly; this solution, however, had the limitation of creating a close interdependence between said two movements. A second object of the present invention is hence that of providing a cutting assembly which does not provide any impediment to the fast, 180° rotation of the disc-holder unit thereof and which hence allows the free and fast positioning on the right hand side or on the left hand side of the cutting assembly, despite maintaining full independence between the two above-said movements thereof.

A third drawback of known cutting assemblies further lies in the difficulty of obtaining a quick but at the same time accurate, constant and reliable adjustment over time, of the angle that the cutting disc builds with respect to the direction of advancement of the material (angle of incidence), which angle may vary, according to the type of cut, between 0° and 1°, for the purpose of avoiding burred, non rectilinear cuts or irregular wear of the cutting disc and counterdisc. A third object of the present invention is hence that of overcoming this drawback by offering a cutting assembly equipped with a particularly simple and reliable device for the adjustment of the angle of incidence of the cutting disc.

A fourth drawback of known cutting assemblies stems from the fact that when the cutting assemblies are in a rest position, the blades of the cutting discs are free and can hence seriously injure the operators who have to frequently work precisely in the narrow space existing between the lower part of the cutting assemblies, wherefrom the cutting disc projects, and the resting surface of the material to be cut. In actual fact protection means of the cutting disc have already been proposed, but they have proven both cumbersome and an obstacle to a correct working, so that they are virtually never used in practice. A fourth object of the present invention is hence that of overcoming this drawback offering a cutting assembly provided with effective protection means which are not bulky and do not interfere with the material being processed.

A fifth drawback of known cutting assemblies is inherent in the current adjustment system of the working end stop position of the vertical movement of the cutting device. As a matter of fact, such position must be liable to being adjusted, so as to be able to use different-diameter blades in the cutting assembly, and to allow—depending on the particular type of working process—accurate positioning of the cutting disc in the working position. For this type of adjustment a knob is currently used, arranged in the upper area of the cutting assembly and screwed on a threaded rod integral with the disc-holder unit; the position of the knob on the rod thereby determines the end stop point of the movement lowering the disc-holder unit due to the engagement thereof with a fixed abutment. However, it was noticed that, for various reasons, among which mainly the vibrations resulting from the movement of the mechanical members of the machine wherein the cutting assemblies are inserted, an accidental shift of the knob and hence of the position of the end stop point may occur during the working step. This apparently mundane drawback, however, causes serious problems, both in terms of time wasted to restore exactly the original setting, and in terms of cut imprecisions and defects. A fifth object of the present invention is hence to provide a cutting assembly which overcomes this drawback, thereby avoiding any accidental movement of the end stop point during the working step, also in the presence of vibrations, without having to resort to mechanical stops (Allen screws or clamps) whose operation slows down adjustment.

A sixth drawback of known cutting assemblies is finally connected to the difficulty of maintaining constant optimal conditions of the cutting disc in the cutting position, in terms of correct lubrication and clean condition of the cutting disc from any debris and dusts resulting from the cut material. A sixth object of the present invention is hence that of providing a cutting assembly provided with a simple and compact device for the lubrication of the cutting disc and/or for cleaning the cutting area.

All the objects highlighted above are reached through a cutting assembly having the features defined in claim 1. Further advantages and features of the cutting assembly of the present invention will hence be clear in the following description and will be highlighted in the dependent claims, which define some preferred, additional characterising elements of such cutting assembly.

Further details on the features and advantages of the cutting assembly according to the invention will nevertheless be more evident from the following description of some preferred embodiments thereof, given by way of example and illustrated in the accompanying drawings, wherein:

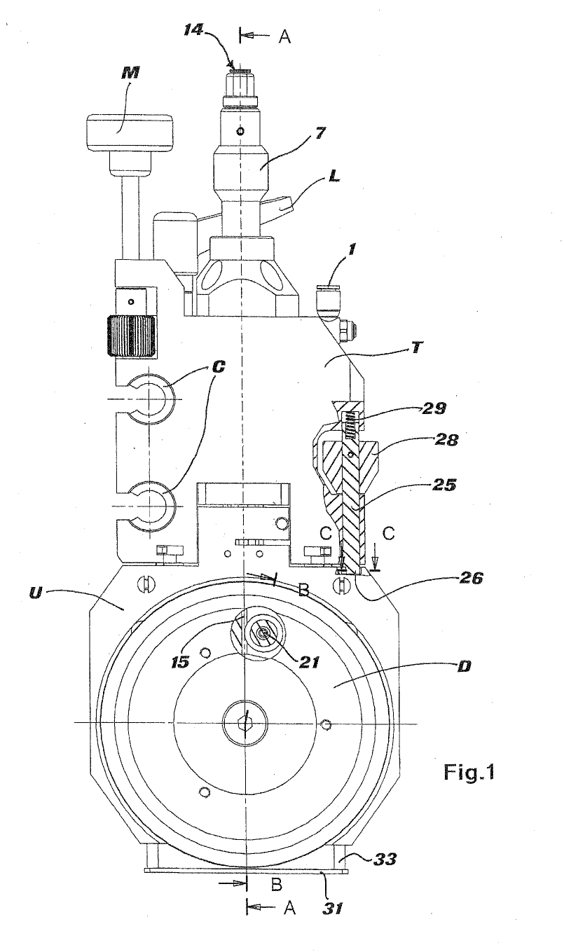

FIG. 1 is an elevated side view of a first embodiment of the cutting assembly according to the present invention, provided with a disc for rotary shear cutting;

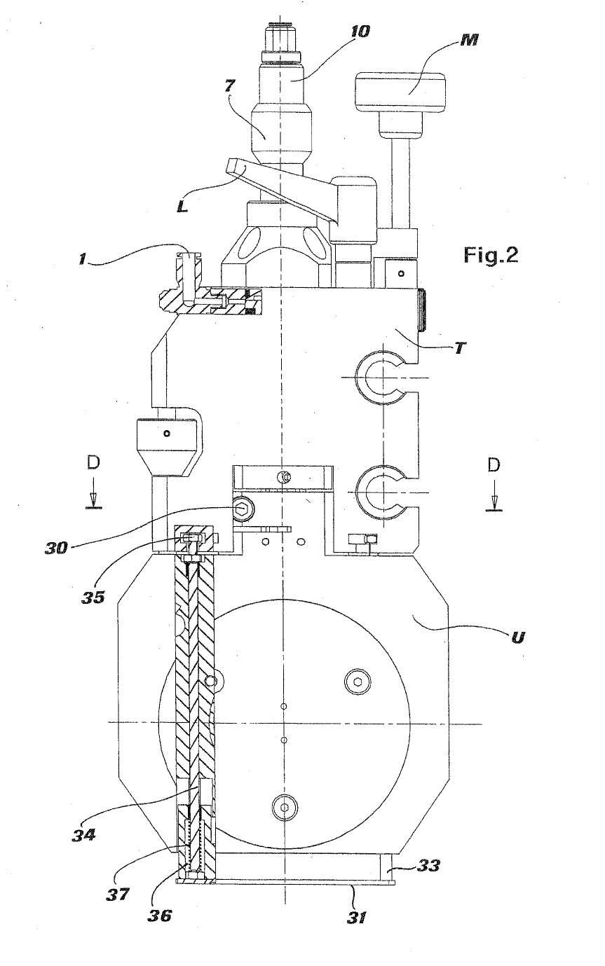

FIG. 2 is an elevated view of the other side of the cutting assembly of FIG. 1, wherein there is further highlighted, in a partial cross-section, the control mechanism of a mobile protection of the cutting disc;

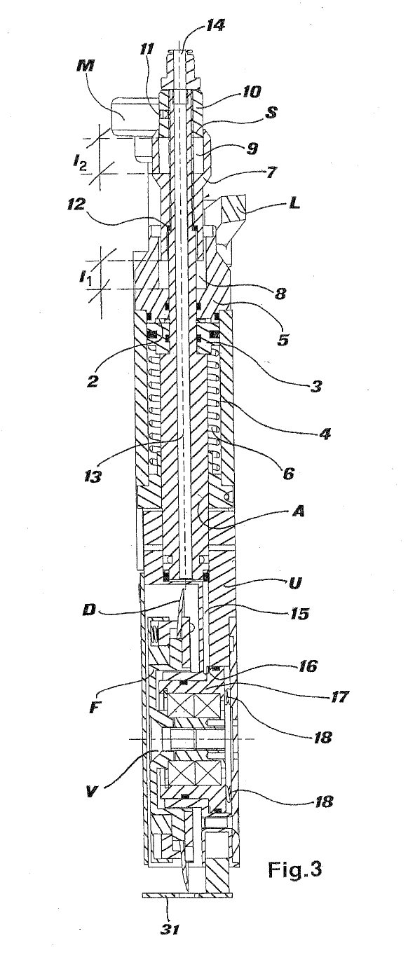

FIG. 3 is a cross-section view of the cutting assembly, according to line A-A of FIG. 1;

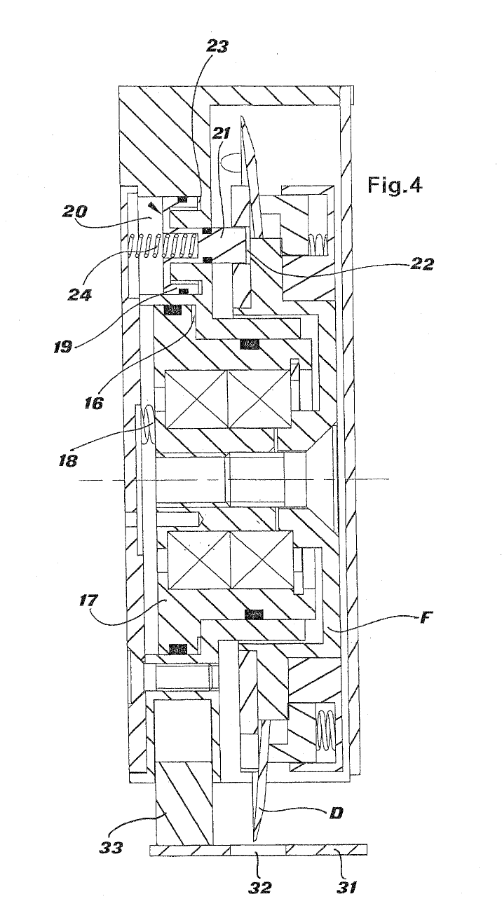

FIG. 4 is a cross-section view, in an enlarged scale, of the disc-holder unit according to line B-B of FIG. 1;

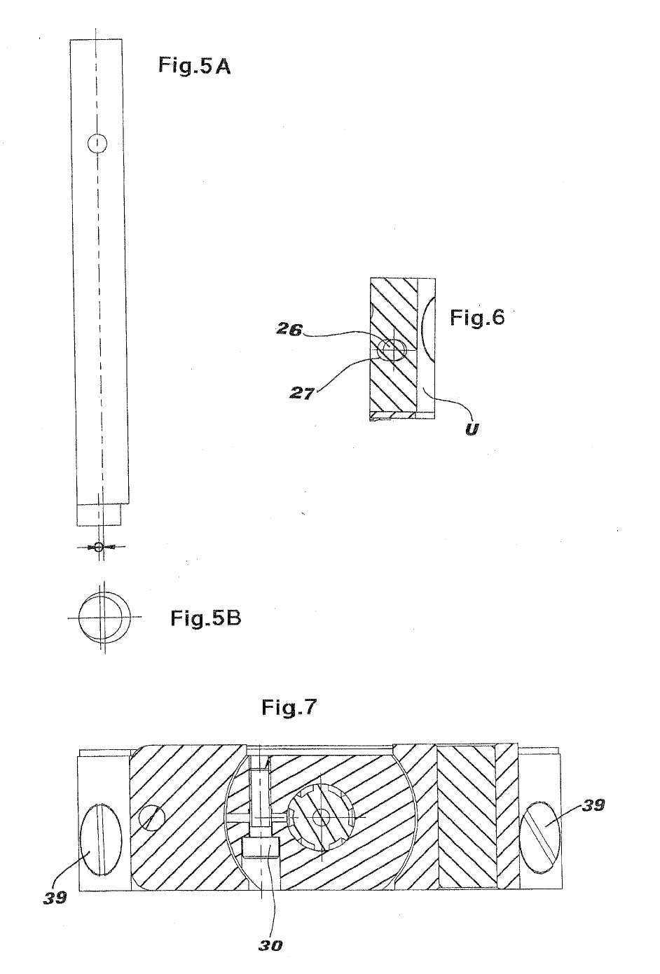

FIGS. 5A and 5B are lateral and top-plan, enlarged-scale views, respectively, of the dowel for the adjustment of the angle of incidence of the cutting disc;

FIG. 6 is a cross-section view of the head of the adjustment dowel of FIG. 5 and of the corresponding housing in the disc-holder unit, according to line C-C of FIG. 1;

FIG. 7 is an enlarged-scale, cross-section view, of the disc-holder unit, according to line D-D of FIG. 2;

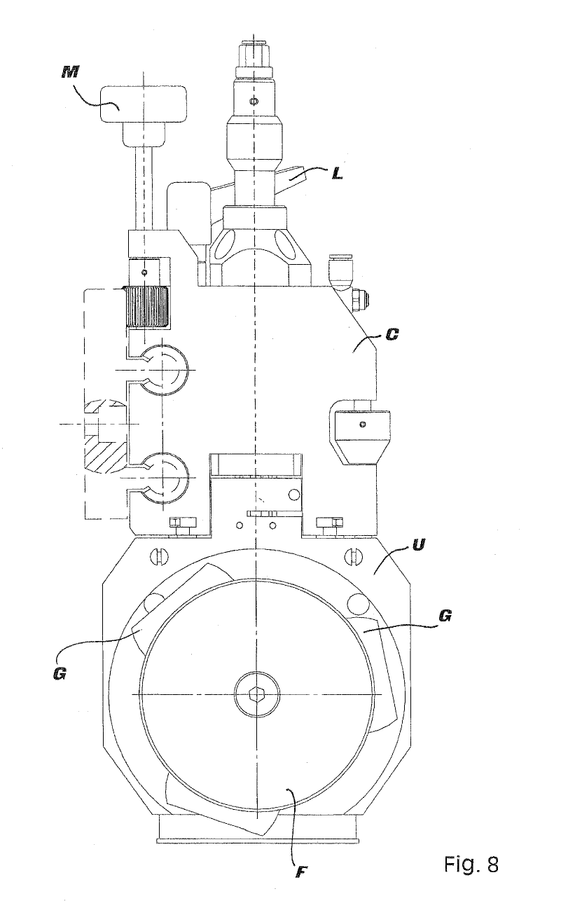

FIG. 8 is an elevation side view of a second embodiment of the cutting assembly according to the present invention, provided with a disc for blade cutting;

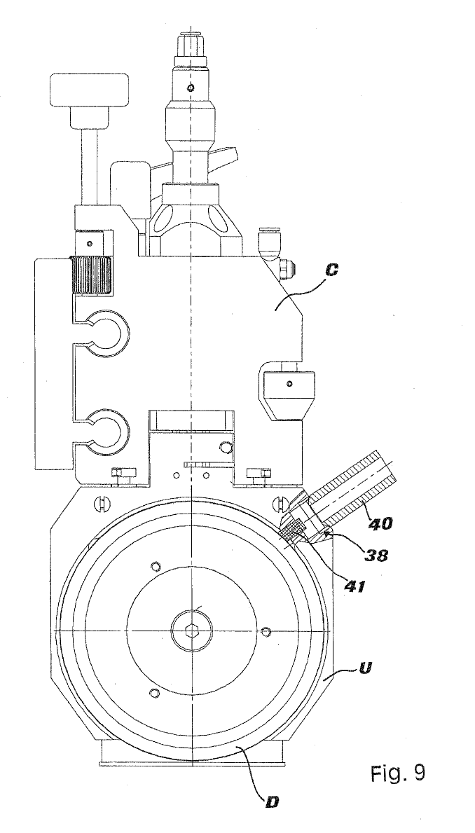

FIG. 9 is an elevation side view of the cutting assembly of FIG. 1, provided with a lubrication device of the cutting disc; and

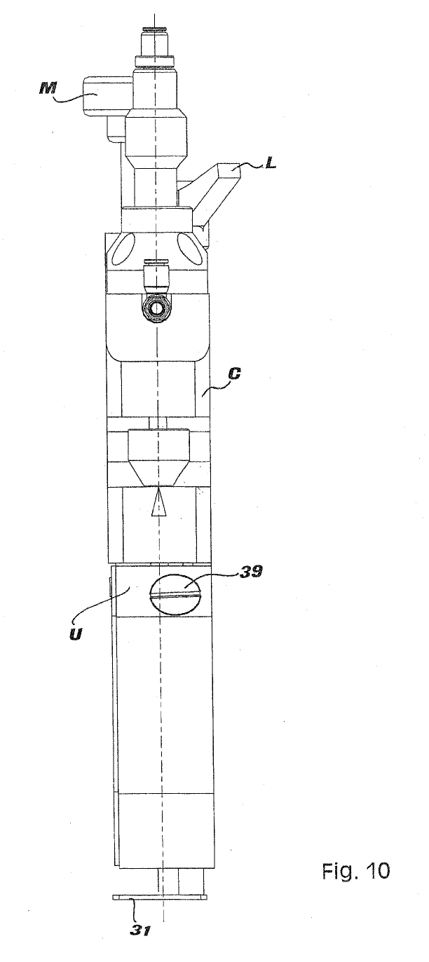

FIG. 10 is an elevation front view of the cutting assembly of FIG. 1.

With reference to FIG. 1, the cutting assembly according to the present invention comprises, in a manner known per se, an upper support body T which is slidingly coupled with guide and support rails (not shown) through a corresponding pair of cylindrical cavities C (other types of guiding rails being of course possible). A control knob M, which ends in a pinion coupled with a rack integral with the rails, allows the fine adjustment of the position of support body T along the rails, whereon it can finally be locked, in the desired position, through a clamp lever L. On support body T there is finally pivoted, along a vertical axis, a disc-holder unit U wherein a cutting disc D is housed, normally pre-mounted on a support flange F (FIG. 4).

The vertical movement of unit U to displace disc D from the rest position to the working position, and viceversa, is achieved through a conventional pneumatic control which comprises a side inlet 1 of compressed air formed on support body T (FIG. 2), said inlet being in fluid communication with chamber 2 (FIG. 3) of a piston 3 with which disc-holder unit U is made integral through a connection shaft A. Piston 3 is free to move vertically within a cylinder 4 between the rest position illustrated in FIG. 3, wherein piston 3 abuts against the head 5 of cylinder 4, and a working position (not shown) wherein piston 3 is displaced downwards by the desired measure, in contrast to spring means 6 housed within cylinder 4. While the rest/end stop position of piston 3 is fixed, being as said determined by the head 5 of cylinder 4, its working end stop position is adjustable, in order to be able to easily adjust to the diameter of cutting disc D and to the different cutting requirements of each individual working step.

According to the invention, the adjustment of the working end stop position of piston 3 is achieved (FIG. 3) through a threaded metal ring nut 7 which is internally threaded and screwed on a corresponding externally-threaded portion of a stem S of piston 3. The lower portion of ring nut 7 is housed in a corresponding cavity 8 formed within head 5 of cylinder 4 and the height l₁ of the clearance remaining between said lower end of ring nut 7 and the bottom of cavity 8 hence represents the useful stroke which piston 3 can perform, under the action of the compressed air introduced from inlet 1, before the lower end of ring nut 7, drawn by stem S, abuts against the bottom of cavity 8.

By screwing on and off ring nut 7 on stem S it is hence possible to adjust at will the length of stroke l according to the different working requirements. For this purpose, ring nut 7 has an upper cavity 9, having a clear span depth 12, which a cylindrical nut 10 enters—itself screwed on stem S and locked in the desired position though a bead 11—as ring nut 7 is gradually made to rotate on stem S. Preferably, stem S and ring nut 7 further have, in correspondence of the mutual coupling area, two different, step-connected diameters. Thereby the adjustment travel of ring nut 7 is limited downwards—in a fixed way—due to the abutment between different-diameter portions of stem S and of ring nut 7 (position shown in FIG. 3) and upwards—adjustably by varying the position of nut 10—due to the abutment of the lower end of nut 10 on the bottom of cavity 9 of ring nut 7.

The stroke of piston 3 can hence be varied with high precision between a minimum length of l₁ and a maximum length of l₁+l₂. The current end stop position of piston 3 can be viewed simply and effectively through a scale member applied in an easily visible position, for example a graduated scale attached to the outer surface of nut 10, the reading of such scale being performed in correspondence of the upper edge of ring nut 7.

According to a peculiar feature of the invention, ring nut 7 is constantly elastically braked, in any point of the adjustment travel thereof, so as to avoid any accidental movement of the threaded metal ring due to machine vibrations during the working step. Such elastic braking action may be obtained very simply, through the particular adjustment structure described above, by introducing an elastomeric ring (O-ring) 12 between ring nut 7 and stem S, as illustrated in FIG. 3. Alternatively, such elastomeric ring can be introduced into suitable seats (not shown in the drawings) between the upper end of ring nut 7 and nut 10, or between the lower end of the same ring nut 7 and the inner walls of cavity 8. A similar result can be achieved also introducing in cavities 8 or 9 helical springs having a size and force suited to impart a moderate friction action between the mutually rotating parts.

When the cutting assembly is used for performing the rotary shear cut, at the end of the vertical movement of unit U to the working position, it is necessary to shift in a horizontal direction disc D from a distant position to one in contact with the counterdisc. The same requirement is present also when using the cutting assembly for performing the pressure cut, except for the fact that the order of the shifting operations of disc D is inverted, since it is necessary to shift the disc-holder unit first into a lateral direction, so as to bring cutting disc D onto the vertical of the respective counterdisc, simultaneously releasing a safety locking device of the cutting disc better described in the following, and hence in a vertical direction as far as bringing the cutting disc in pressure contact with said counterdisc.

For the purpose of performing the lateral horizontal movement of cutting disc D, it is already known that flange F supporting disc D is rotatably mounted on a pneumatically actuatable piston having a horizontal axis and supported by disc-holder unit U. In the known art, as already detailed in the preliminary remarks of the present description, the pressurised fluid for said piston controlling the lateral displacement of the disc-holder unit with respect to the main body of the cutting assembly is fed through outer pipes. The presence of said pipes, however, is an obstacle, as said, to the rapid and easy, 180° rotation of the disc-holder unit U of the cutting assembly, since it is necessary to detach the pipes from the cutting unit before performing the rotation thereof, and to then provide to the subsequent renewed mounting thereof in a different position once the rotation has occurred.

On the contrary, according to an innovative feature of the present invention, the supply of compressed air for controlling the horizontal displacement of cutting disc D is not directly linked to the disc-holder unit, but rather to non-rotating, upper support body T of the cutting assembly, wherefrom the compressed air is then led to the disc-holder unit exclusively through channels formed inside the same cutting assembly, so as to remove at the root any kind of outer bulk and to make the supply of compressed air independent from the right/left position of cutting unit U. This solution remarkably simplifies all the operations of installation, positioning, use and maintenance of the cutting assembly and, in particular, makes it possible for the disc-holder unit to rotate by 180° quickly and easily, without any external element which may hinder this operation and without the need to change in any way the supply of the pressurised fluid.

In order to reach this goal, and as clearly illustrated in FIG. 3, stem S and connection shaft A—preferably but not necessarily integrally formed—have a long, axial hole which extends along the entire length thereof to form a throughway 13 for supplying compressed air from inlet port 14, located at the top of the assembly, through an inner channel 15 formed in disc-holder unit U, up to the expansion chamber 16 of piston 17 whereto, in a manner known per se, there is fixed flange F supporting disc D. The movement imparted to piston 17 by the compressed air supplied through channels 13 and 15 occurs, again in a manner known per se, in contrast to the action of springs 18, capable of maintaining flange F and disc D in a rest position when the supply of compressed air ceases.

According to a main feature of the present invention, illustrated in the detail of FIG. 4, the disc-holder unit U is further equipped with a safety locking device to prevent the accidental rotation of cutting disc D when the disc is in a rest position i.e. when no pressurised fluid is supplied to inlet port 14. Such device consists of a small piston 19 housed in a cylindrical chamber 20 formed in the body of unit U and provided with a pin 21 projecting towards cutting disc D and capable of entering one or more holes 22 provided on the inner surface of flange F.

The expansion chamber 23 of piston 19 is in fluid connection with the afore-mentioned expansion chamber 16 of piston 17, so that when compressed air is introduced in the latter from inlet port 14, in addition to the horizontal movement of flange F and of the thereby supported cutting disc D, retraction of pin 21 also takes place, in contrast with the action of spring 24, thereby freeing hole 22 and cutting disc D. When the supply of compressed air ceases, spring 24 immediately brings pin 21 back into engagement with hole 22, thereby preventing any accidental rotation of cutting disc D.

It must be appreciated that the above-illustrated locking device, in addition to the above-described safety function, also has another aim, namely that of allowing the universal use of the cutting assembly also for the so-called blade cut (FIG. 8). As a matter of fact, in this case the cutting assembly is equipped with a flange F having fixed on the periphery thereof, in a suitable position and angle, one or more blades G. These blades G are intended to work in a fixed position and with a suitable inclination on the material to be cut, which translates underneath the same, i.e. without any rotation of support flange F. With the cutting assembly of the present invention it is hence sufficient, in order to accomplish this type of cut, to close compressed air inlet port 14, and flange F automatically remains locked in rotation. Upon changing blade G in the working process, it will be sufficient to supply compressed air to inlet port 14 for a few moments, to rotate disc D until the correct positioning of a new blade, and to then deactivate the supply, to cause flange F to remain immediately and safely locked in the new position. By this system there is also the advantage of a quick fastening of the blade in the exact, correctly preset inclination, such inclination being determined, once for all, by the mutual position between hole 22—which on each occasion is in correspondence of pin 21—and the fastening means of corresponding blade L in a working position.

The above-said safety locking device further has another significant advantage during mounting/removal from the cutting unit of flange F supporting disc D. As a matter of fact, whereas in known devices it is necessary to manually prevent rotation of the blade when a tightening/loosening torque is imparted onto screw V locking flange F, in the device of the invention this action becomes fully superfluous due to the presence of the above-said safety locking device which prevents any undesired rotation of the cutting disc during the above-said mounting/removal operations, with great advantage for operator safety and operation speed.

In the rotary shear cut, as is well-known to people skilled in the field and as recalled in the preliminary remarks of the present disclosure, it is necessary to adjust the angle of incidence of cutting disc D on the counterdisc. According to the present invention such adjustment occurs with a very simple and reliable device, which allows to perform the adjustment accurately at high speed and guarantees a total consistency over time of the set angle.

Such device (FIG. 1) consists of a dowel 25 housed in a respective cylindrical seat formed in the upper support T of the cutting assembly and equipped with an eccentric head 26 which protrudes from upper support T and engages with a corresponding eyelet-shaped slot 27. Said slot is formed on the upper part of unit U and is of a constant height equal to the diameter of eccentric head 26, except for the coupling allowance.

In the use it is firstly provided to slacken screw 30 (FIGS. 2 and 7) of a clamp which locks unit U on shaft A of support body T. By then rotating dowel 25, through a graduated knob 28 integral therewith, eccentric head 26 causes a lateral rotation of unit U about shaft A, with respect to a zero position wherein such unit is aligned with support body T, thereby allowing to adjust the angle of incidence of cutting disc D. The value of the angle of incidence can be controlled on a suitable graduated scale applied onto knob 28 with reference to an abutment index on support body T (see also FIG. 10). Once the correct angle of incidence has been determined, unit U is fastened in this position by tightening again screw 30 of the clamp.

When disc-holder unit U must be rotated by 180°—for example to exploit better the potential of some types of counterdiscs, or in order to be able to accomplish cuts to the right or to the left of the main axis of the cutting assembly—it is firstly necessary to loosen tightening screw 30 and then lift eccentric-head dowel 25, in contrast to spring means 29 which are housed in a respective seat of upper support body T, wherein the free upper end of dowel 25 engages, with a certain free travel in its axial direction. Once rotation has occurred, dowel 25 is released so that its head 26 engages with one corresponding slot 27—two slots being formed on both sides of unit U—and finally the above-said screw 30 is tightened again, after having adjusted the new angle of incidence, thereby immediately putting the cutting assembly in a condition to work effectively.

The cutting assembly of the present invention is then also provided with a mobile protection of the cutting disc, capable of preventing any accidental contact between the operator and the sharp edge of cutting disc D, when the cutting unit is not in a working position. This protection is particularly advantageous because it enables the operator to work freely under the cutting assemblies, both during the initial step of preparing the material to be cut, and in any control or maintenance operation, without having to fear dangerous accidental contact with the sharp edge of disc D.

The above-said mobile protection device consists of a rectangular screen 31 arranged under cutting disc D and provided with a central opening 32, itself rectangular, for the passage of the disc in a working position. Screen 31 is movable in the direction of the axis of the cutting assembly, due to suitable guides 33 integral therewith and slidable within corresponding channels formed in the cutting unit (FIG. 4), between a rest position, illustrated in the drawings, and a working one wherein it is perfectly in contact with the lower side of the cutting unit.

The travel of screen 31 is controlled by a pair of rod-shaped end stops housed within cutting unit U, one whereof is shown in a partial cross-section view in FIG. 2. Each of said end stops comprises a vertical rod 34, whose upper end is axially restrained to support body 1 through the coupling between an enlarged head 35 of rod 34 (a simple nut tightened on the threaded end of rod 34 in the illustrated embodiment) and a corresponding cavity shaped as an arch of a circle (lying on a surface perpendicular to the axis of rotation of unit U and having its centre on said axis) formed on support body T, wherein enlarged head 35 can freely move whenever unit U is rotated by 180°. The opposite end of rod 34 is instead freely housed in a chamber 36, integral with screen 31, wherein spring means 37 are mounted, capable of maintaining the end of rod 34 constantly pushed against screen 31.

When unit U is in a rest position, screen 31 is in the position illustrated in the drawings, fully outside the sharp edge of disc D, and cannot be moved from this position due to the presence of rod 34 which abuts on one side against support body 1 and on the other side against screen 31. Such screen hence represents an effective and fixed protection from possible contact of the operator's fingers with the edge of cutting disc D. When unit U is then lowered into its working position, rod 34 remains integral with support body 1, whereto it is anchored with head 35, and hence drags with itself screen 31, due to the tension of spring 31, until the screen comes into contact with the wall of unit U, in a position which corresponds to the minimum cutting depth of the cutting assembly. When the cutting depth is increased, by acting on ring nut 7, unit U has a longer travel, but screen 31 is still capable of following the movement thereof without problems, thanks to the progressive compression of spring means 37. It is further to be appreciated that, thanks to its completely flat shape, screen 31—when it is in its working position in contact with the lower wall of cutting unit U—does not offer any possible obstacle to the material being processed and does not create any interference with the cut material or with the corresponding off-cuts, hence fully eliminating the long and unpleasant cleaning operations which are sometimes necessary with known-type protections.

Finally, the cutting assembly of the present invention can be usefully provided with a disc-cleaning system which, depending on the type of process under way, can consist of a blade lubrication device, of a device sucking debris and process dusts, or of both such devices. These devices are mounted on cutting unit U, according to requirements, in correspondence of two threaded cavities 38 formed on the upper part of said unit U, which open within the same in correspondence of the blade of cutting disc D and are normally closed on the outside by screw caps 39, well-visible in FIGS. 7 and 10.

The blade lubrication device, illustrated in a cross-section view in FIG. 9, simply consists of a small tank 40 of lubricant screwed in cavity 38 and provided on the front side with a wick 41 of a porous, absorbing material (sponge cloth, felt and the like) intended to be kept in contact with the blade of cutting disc D, possibly pushed against said blade by suitable spring means.

The dust and debris sucking device instead consists of a simple flexible pipe (not shown) connected at one end to an outer sucking device and at the other end to one of the two cavities 38 of unit U.

In a preferred embodiment of cavities 38, said cavities have two distinct outlet ports in the area of cutting disc D. A first port, having an axis substantially parallel to the rotation axis of disc D, opens out on the disc side, in the proximity of the periphery thereof, and is intended to clean the blade side. A second port, with an axis substantially perpendicular to the disc rotation axis and lying on the surface thereof, instead opens out in front of the edge of the blade for the cleaning whereof it is indeed intended. In the case of the cleaning device, in this embodiment two separate wicks will hence be provided, arranged in the above-said two ports and supplied by the only tank 40 of lubricant. In the case of the sucking device a double sucking is obtained, again through the only cavity 38, both in front of and sideways to the blade, with a more thorough cleaning action.

From the preceding description it is evident how the cutting assembly according to the present invention has fully achieved all the set objects. As a matter of fact, thanks to the provision of the automatic locking device of the cutting disc and to the independence of the controls of the two displacements of the disc-supporting flange, the cutting assembly may be used directly for any type of cut, by simply replacing the cutting disc; i.e. it is a universal cutting assembly. Due to the provision of inner air channels also for controlling the lateral displacement of the flange and to the adjustment device of the angle of incidence, the cutting assembly can be moved very quickly and accurately into the right/left cutting positions. Thanks to the adjustment device of the working travel, the cutting assembly can operate with a perfectly controlled cutting depth which is constant over time, even in the presence of strong machine vibrations. Through the movable protection device, a high level of safety of the cutting assembly is achieved, without any obstacle or technical drawback during processing. Finally, through the cleaning system, the process of the cutting assembly can continue uninterruptedly for long periods of time, without the need for breaks for assembly cleaning and maintenance.

The present invention has been described with special reference to preferred embodiments of the same, illustrated in the drawings, but it is clear that a number of various changes can be made to the same, all within the obvious reach of a person skilled in the field, and all hence falling within the scope of protection of the invention, which is hence only defined by the accompanying claims.

1) Universal cutting assembly for rotary shear, pressure or blade cutting machines of different sheet materials, of the type comprising a fixed upper support body (T), a disc-holder unit (U) connected to said support body so as to be able to rotate by at least 180° along a vertical axis, a support flange (F) for a cutting disc (D) housed in the disc-holder unit (U) and capable of a perpendicular displacement to the cutting surface for moving disc (D) closer to/away from the cutting area, said movement being driven by the action of a pressurised fluid on first piston means (3), and of a displacement parallel to the cutting surface for positioning the disc (D) with respect to a counterdisc arranged below the cutting surface, said movement being driven by the action of a pressurised fluid on second piston means (17), characterised in that said disc-holder unit (U) comprises an automatic stopping device of the cutting disc (D) in a rest position.

2) Universal cutting assembly as claimed in claim 1), characterised in that said stopping device consists of a small piston (19) which can be actuated by fluid pressure and is provided with a pin (21) projecting to the cutting disc (D) capable of engaging with one or more holes (22) provided on the respective flange (F).

3) Universal cutting assembly as claimed in claim 2), wherein the expansion chamber (23) of piston (19) is in fluid connection with the expansion chamber (16) of said second piston means (17).

4) Cutting assembly as claimed in claim 1), wherein the supply of pressurised fluid to the piston means (17) which determine said movement parallel to the cutting surface of the flange (F) comprises channels (13-16) formed, at least partly, within the disc-holder unit (U) and the upper support body (T) of the cutting assembly.

5) Universal cutting assembly as claimed in claim 4), wherein said channels (13-16) formed within the cutting assembly open outwards with an inlet port (14), apt to be connected to an outer supply of pressurised fluid, in correspondence of a portion of the cutting assembly different from said disc-holder unit (U).

6) Universal cutting assembly as claimed in claim 5), wherein said inlet port (14) is arranged in an axial position at the top of the cutting assembly.

7) Universal cutting assembly as claimed in claim 6), wherein said channels formed within the cutting assembly comprise, starting from said inlet port (14): an axial channel (13), a channel (15) formed in the disc-holder unit (U), and an expansion chamber (16) of said second piston means (17).

8) Universal cutting assembly as claimed in claim 7), wherein said axial channel is formed within a shaft assembly (A, S) integral with said first piston means (3) and axially slidable with respect to the upper support body (T) of the cutting assembly, to control the movement perpendicular to the cutting surface of said flange (F).

9) Universal cutting assembly as claimed in claim 8), wherein said shaft assembly comprises: a connection shaft (A) which makes said first piston means (3) and said disc-holder unit (U) mutually integral in an axial direction; a stem (S) of said first piston means (3), which extends above the same to house an end stop device of the displacement of said piston means towards the working position.

10) Universal cutting assembly as claimed in claim 9), characterised in that said stem (S) is formed integrally with said shaft (A).

11) Universal cutting assembly as claimed in claim 9), wherein said working end stop device comprises an internally threaded metal ring (7), screwed on a corresponding, externally threaded portion of said stem (S), said threaded metal ring (7) being capable of abutting against a fixed abutment (8) integral with said upper support body (T) of the cutting assembly.

12) Universal cutting assembly as claimed in claim 11) further comprising controlled-friction means (12) arranged between a surface of said threaded metal ring (7) and an adjacent, suitable abutment surface, to keep the threaded metal ring (7) constantly braked.

13) Universal cutting assembly as claimed in claim 12), wherein said controlled-friction means consist of an elastomeric ring (O-ring) (12) housed in a seat formed between the threaded metal ring (7) and said stem (S).

14) Universal cutting assembly as claimed in claim 13), wherein said seat of the elastomeric ring (12) is formed in an area where said stem (S) and said threaded metal ring (7) have a step variation of the respective diameters thereof.

15) Universal cutting assembly as claimed in claim 12), wherein said controlled-friction means consist of a helical spring housed within cavities (8, 9) formed around said stem (S), at least one of the walls of said cavities consisting of said threaded metal ring (7).

16) Universal cutting assembly as claimed in claim 1) further comprising an adjustment device of the angle of incidence of the cutting disc (D) on the counterdisc, said device consisting of a dowel (25) housed in a cylindrical seat formed in the upper support body (T) of the cutting assembly and provided with an eccentric head (26) which protrudes from body T and engages with at least one corresponding eyelet-shaped slot (27) formed on the upper part of unit U and having a constant height equal to the diameter of said eccentric head (26).

17) Universal cutting assembly as claimed in claim 16), wherein said dowel (25) is provided with axial clearance, in contrast to spring means (29), in order to allow the temporary slipping off of the eccentric head (26) from the eyelet-shaped slot (27) during the rotation operation of the disc-holder unit (U).

18) Universal cutting assembly as claimed in claim 1), characterised in that it comprises a mobile protection of the cutting disc, in a rest position, consisting of a rectangular screen (31) with a central opening (32) for the cutting disc (D) to move into a working position, said screen (31) being movable towards the axis of the cutting assembly between a rest position, below the sharp edge of the disc (D), and a working position, in contact with the lower wall of the cutting unit (U).

19) Cutting assembly as claimed in claim 18), wherein the travel of the screen (31) is controlled by a pair of rod-shaped end stops (34), whose enlarged upper end (35) is freely housed in a corresponding cavity formed on support body T, while the lower end of the rod (34) is elastically restrained to said screen (31).

20) Cutting assembly as claimed in claim 19), wherein said cavity is shaped as an arch of a circle lying on a surface perpendicular to the axis of rotation of cutting unit U and centred on said axis.

21) Cutting assembly as claimed in claim 19), wherein the lower end of the rod (34) is freely housed in a chamber (36) integral with said screen (31), spring means (37) being arranged between a wall of said chamber (36) and said end of the rod (34) to keep the same in contact with said screen (31).

22) Universal cutting assembly as claimed in claim 1), characterised in that it further comprises a cleaning system of the cutting disc comprising a lubrication device and/or a device sucking debris or process dusts.

23) Cutting assembly as claimed in claim 22), wherein said devices are attached to corresponding cavities (38) formed on the upper part of the cutting unit (U) and extending internally thereof up to an area in the proximity of the blade of the cutting disc (D).

24) Universal cutting assembly as claimed in claim 23), wherein said lubrication device comprises a tank (40) of lubricant fastened to one of said cavities (38) and a wick (41) of a porous, absorbing material associated with said tank.

25) Cutting assembly as claimed in claim 24), wherein said wick is kept in contact with the blade of the cutting disc (D) by spring means housed in said tank.

26) Universal cutting assembly as claimed in claim 23), wherein said sucking device comprises an outer sucking pipe fastened to one of said cavities (38).
